(19) United States
(12) Patent Application Publication
(10) Pub. No.: US 2012/0291530 A1
(43) Pub. Date: Nov. 22, 2012

(54) CONCENTRATION DETECTING APPARATUS

(75) Inventor: Keiichiro Aoki, Sunto-gun (JP)

(73) Assignee: TOYOTA JIDOSHA KABUSHIKI KAISHA, Toyota-shi (JP)

(21) Appl. No.: 13/522,295

(22) PCT Filed: Jan. 14, 2010
(86) PCT No.: PCT/JP2010/050331

§ 371 Date: Jul. 13, 2012

(51) Int. Cl. G01N 27/04

(52) U.S. Cl. 73/61.43

(57) ABSTRACT

A concentration detecting apparatus that detects the alcohol concentration of an alcohol blended fuel includes frequency controlling means that controls the frequency of an alternating-current voltage applied between a pair of electrodes spaced apart from each other. A first resistance constituent value between the electrodes is detected by applying an alternating-current voltage at a first frequency at which a capacitance constituent value of the impedance is zero. Similarly, a second resistance constituent value between said electrodes is detected by applying an alternating-current voltage at a second frequency different from the first frequency at which the capacitance constituent value of the impedance is zero. The alcohol concentration is calculated based on the difference between the first resistance constituent value and the second resistance constituent value.

### TECHNICAL FIELD

The present invention relates to a concentration detecting apparatus. More specifically, it relates to a concentration detecting apparatus suitable for detection of the alcohol concentration of an alcohol blended fuel supplied to an internal combustion engine.

### BACKGROUND ART

From the view point of reducing gasoline consumption, alcohol, which emits smaller amounts of CO and HC, has recently been attracting attention as a fuel for internal combustion engines. A known example is a flexible-fuel vehicle (FFV) provided with an internal combustion engine capable of running on an alcohol blended gasoline. Fuel mixtures containing alcohol have different optimum air-fuel ratios depending on the alcohol concentration. Therefore, to properly control the air-fuel ratio, there is a demand for a simple apparatus that can more accurately grasp the alcohol concentration of the fuel mixture.

Patent Literature 1 discloses a conventional concentration detecting apparatus that detects the alcohol concentration of an alcohol blended fuel. In the concentration detecting apparatus according to Patent Literature 1, an alcohol concentration sensor and a coil L are connected in series with each other. The conductivity of the alcohol concentration sensor is detected by applying a low current to the circuit. In addition, the resonance frequency of the LC resonant circuit formed by the alcohol concentration sensor and the coil L is detected as an equivalent capacitance value. The frequency is converted into a voltage value by a frequency-voltage conversion calculation, thereby calculating the capacitance of the alcohol concentration sensor. The concentration detecting apparatus according to Patent Literature 1 determines the alcohol concentration of the fuel mixture based the capacitance.

### CITATION LIST

### Patent Literature

### Patent Literature 1: Japanese Utility Model Laid-Open No. 5-33054

### Patent Literature 2: Japanese Patent Laid-Open No. 7-306172

### Patent Literature 3: Japanese Patent Laid-Open No. 2009-145131

### SUMMARY OF THE INVENTION

### Problem to be Solved by the Invention

In the conventional concentration detecting apparatus such as disclosed in Patent Literature 1, the conductivity and the capacitance are detected by detecting the voltage and the resonance frequency in the entire circuit including the alcohol concentration sensor and the capacitor, the coil and the like connected to the sensor. Therefore, the detection values include not only a constituent value attributed to the fuel but also constituent values attributed to other factors, such as the electrode of the sensor, the capacitor, the coil, the lead and the like (referred to collectively as the electrode and the like hereinafter). Therefore, variations of the conductivity and the capacitance are influenced not only by the alcohol concentration but also by deterioration of the electrode and the like. Therefore, the more remarkable the deterioration of the electrode and the like, the more remarkable the influence of the deterioration on the variations of the conductivity and the capacitance can be, and the more remarkable the deviation of the calculated alcohol concentration from the actual concentration can be.

In view of such circumstances, an object of the present invention is to solve the problem described above and provide an improved concentration detecting apparatus that can detect an alcohol concentration while reducing error of the detection value due to deterioration of an electrode or the like.

### Means for Solving the Problem

In accomplishing the above object, the first invention is of a concentration detecting apparatus that detects an alcohol concentration of an alcohol blended fuel, the concentration detecting apparatus comprising:

frequency controlling means that controls a frequency of an alternating-current voltage applied between a pair of electrodes spaced apart from each other;

resistance constituent value detecting means that detects a first resistance constituent value between the electrodes in a case where an alternating-current voltage is applied at a first frequency at which a capacitance constituent value of an impedance is zero and detects a second resistance constituent value between the electrodes in a case where an alternating-current voltage is applied at a second frequency different from the first frequency at which the capacitance constituent value of the impedance is zero; and

concentration estimating means that estimates the alcohol concentration based on the difference between the first resistance constituent value and the second resistance constituent value.

The second invention, according to the first invention, further comprises temperature detecting means that detects a temperature of the alcohol blended fuel,

wherein the concentration estimating means estimates the alcohol concentration based on the difference between the first resistance constituent value and the second resistance constituent value and the temperature detected by the temperature detecting means.

The third invention, according to the first invention, further comprises:

capacitance constituent value calculating means that calculates the capacitance constituent value between the electrodes in a case where a predetermined third frequency between the first frequency and the second frequency is applied; and

temperature estimating means that determines a temperature of the alcohol blended fuel based on the difference between the first resistance constituent value and the second resistance constituent value and the capacitance constituent value.

The fourth invention, according to the first or the second invention, further comprises:

a temperature detecting means that detects the temperature of the alcohol blended fuel;

capacitance constituent value calculating means that calculates the capacitance constituent value between the electrodes in a case where a third frequency between the first frequency and the second frequency is applied; and

water concentration calculating means that calculates a water concentration of the alcohol blended fuel based on the difference between the first resistance constituent value and the second resistance constituent value, the capacitance constituent value and the temperature detected by the temperature detecting means.

### Effects of the Invention

According to a first aspect of the present invention, the alcohol concentration is determined based on the difference between the first resistance constituent value and the second resistance constituent value that are associated with the alternating-current voltages at different first and second frequencies at both of which the capacitance constituent value of the impedance is zero. Therefore, the resistance constituent values attributed to the electrode, the leads or the like in the concentration detecting apparatus can be removed from the resistance of the entire circuit of the apparatus. As a result, the influence of the deterioration or the like of the electrodes or the like on the detection value can be removed, and the alcohol concentration can be accurately determined based only on the resistance constituent value attributed to the fuel.

According to a second aspect of the present invention, the alcohol concentration is estimated based on the difference between the first resistance constituent value and the second resistance constituent value and the temperature of the fuel mixture. Since the conductivity of the alcohol varies with the temperature, the alcohol concentration can be more accurately estimated by taking the temperature into consideration.

According to a third aspect of the present invention, not only the first resistance constituent value and the second resistance constituent value but also the capacitance constituent value associated with the predetermined third frequency is calculated. Both the resistance constituent value and the capacitance constituent value have correlations with the temperature. Therefore, not only the alcohol concentration but also the temperature can be detected by detecting the difference between the first resistance constituent value and the second resistance constituent value and the capacitance constituent value. As a result, there is no need for additionally installing the temperature sensor or the like, and the cost of the system can be reduced.

According to a fourth aspect of the present invention, the alcohol concentration and the water concentration of the fuel mixture can be detected by using the difference between the first resistance constituent value and the second resistance constituent value, the capacitance constituent value and the temperature as parameters. Therefore, the properties of the fuel can be more accurately detected, and the air-fuel ratio can be more precisely controlled.

### BRIEF DESCRIPTION OF DRAWINGS

FIG. 1 is a schematic diagram for illustrating entirely arrangements of a system according to an embodiment 1 of the present invention.

FIG. 2 is an equivalent circuit diagram of a concentration detecting apparatus 2 according to the embodiment 1 of the present invention.

FIG. 3 is a graph for illustrating variations of the resistance of a metal electrode and a conductive material with temperature.

FIG. 4 is a complex impedance plot showing a variation of the impedance when an alternating-current frequency is applied to the detecting circuit of the concentration detecting apparatus according to the embodiment 1 of the present invention.

FIG. 5 is a flowchart for illustrating a control routine performed by the controller in the embodiment 1 of the present invention.

FIG. 6 is a graph for illustrating a relationship among conductivity, capacitance and temperature of the concentration detecting apparatus according to an embodiment 2 of the present invention.

FIG. 7 is a flowchart for illustrating a control routine preformed by the controller in the embodiment 2 of the present invention.

FIG. 8 is a graph for illustrating a relationship between equivalent concentration value and water content of the concentration detecting apparatus according to an embodiment 3 of the present invention.

### MODES FOR CARRYING OUT THE INVENTION

In the following, embodiments of the present invention will be described with reference to the drawings. In the drawings, the same or equivalent components are denoted by the same reference numerals, and descriptions thereof will be simplified or omitted.

### Embodiment 1

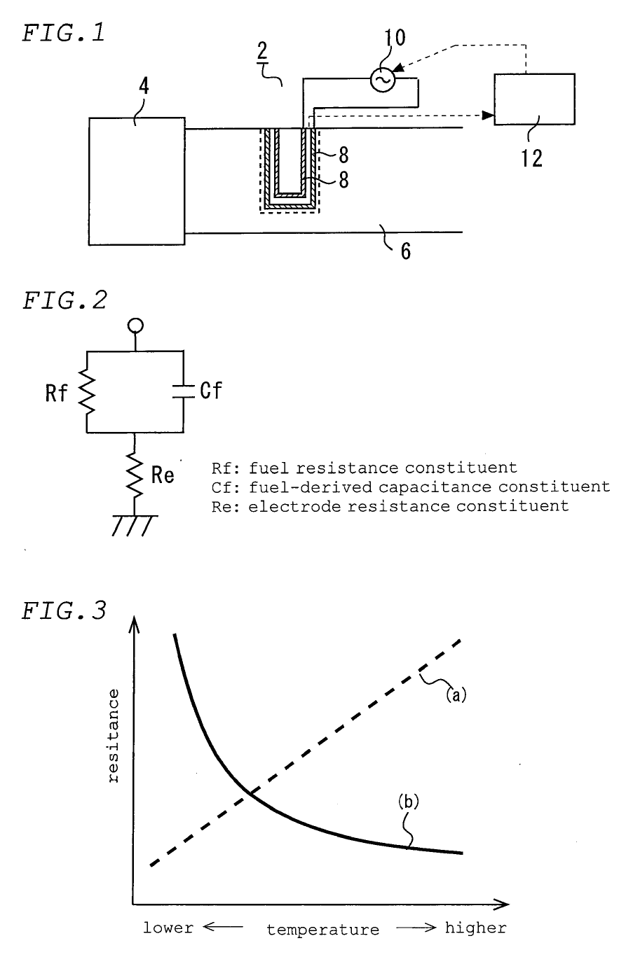

FIG. 1 is a schematic diagram for illustrating a state of installation of a concentration detecting apparatus according to an embodiment 1 of the present invention. As shown in FIG. 1, a concentration detecting apparatus 2 is used to detect the alcohol concentration of a fuel mixture, such as an alcohol blended gasoline. FIG. 1 shows an example in which the concentration detecting apparatus is mounted on a fuel path 6 or the like of an internal combustion engine 4 mounted on a vehicle or the like. However, the site of installation or use of the concentration detecting apparatus 2 according to the present invention is not limited to this site, and the concentration detecting apparatus 2 can be used at any site as required for detection of the fuel concentration.

The concentration detecting apparatus 2 has a pair of electrodes 8 spaced apart from each other. The electrodes 8 are disposed in the fuel path 6 with at least part thereof being in contact with the fuel mixture. The concentration detecting apparatus 2 has an alternating-current power supply 10 connected to the electrodes 8 to apply an alternating-current or direct-current voltage to the electrodes 8. Although not shown in the drawing, the concentration detecting apparatus 2 forms a detecting circuit to which an impedance detector that detects the impedance between the electrodes 8, a frequency detector that detects the alternating-current frequency and the like are connected.

The concentration detecting apparatus 2 further has a controller 12. The controller 12 is connected to various detectors and the alternating-current power supply 10 in the concentration detecting apparatus 2. The controller 12 receives output signals of the detectors, detects the impedance or the like of the concentration detecting apparatus 2, and performs various kinds of calculations based on the information obtained by the detection. In addition, for example, the controller 12 issues a control signal to the alternating-current power supply 10 to control the frequency of the voltage applied to the concentration detecting apparatus 2 or the like.

Gasoline and alcohol in the fuel mixture have significantly different conductivities and dielectric constants. Alcohol has higher conductivity and dielectric constant than gasoline. Therefore, the dielectric constant and the conductivity of the fuel mixture vary more remarkably with the alcohol concentration. Therefore, the alcohol concentration of the fuel mixture can be detected by detecting the resistance value or capacitance between the electrodes 8.

The impedance that occurs when an alternating-current voltage is applied to the concentration detecting apparatus 2 can be broken down into the following constituents:

(1) constituents attributed to the fuel between the electrodes 8; and

(2) constituents attributed to the other factors than the fuel such as the electrodes 8.

Note that the capacitance constituents attributed to the other factors than the fuel, such as the electrodes 8, classified above as the category (2) are canceled by a capacitor inserted in the sensor circuit, for example, and therefore are negligible in this example. Therefore, the concentration detecting apparatus 2 has a configuration shown by the equivalent circuit diagram of FIG. 2.

FIG. 2 is an equivalent circuit diagram showing the concentration detecting apparatus 2 according to the embodiment 1 of the present invention. In the equivalent circuit diagram of FIG. 2, a fuel resistance constituent Rf and a fuel-derived capacitance constituent Cf are constituents attributed to the fuel mixture between the electrodes 8 classified above as the category (1), and the electrode resistance constituent Re is a constituent attributed to other factors than the fuel, such as the electrodes 8, classified above as the category (2).

In the equivalent circuit diagram, the fuel resistance constituent Rf and the fuel-derived capacitance constituent Cf are the constituents that vary with the alcohol concentration of the fuel mixture. Therefore, a variation of the alcohol concentration can be detected by detecting a variation of the fuel resistance constituent Rf.

However, the value of the resistance value detected when an alternating-current or direct-current voltage is applied to the entire circuit includes the electrode resistance constituent Re classified above as the category (2). If the electrode resistance constituent Re were fixed, a variation of the fuel resistance constituent Rf could be easily singly detected. However, the electrode resistance constituent Re varies with deterioration of the electrodes or with temperature.

FIG. 3 is a graph for illustrating variations of the resistance of a metal electrode and a conductive material with temperature, in which the horizontal axis indicates the temperature, and the vertical axis indicates the resistance. In FIG. 3, the dashed line (a) indicates the resistance of the metal electrode, and the curve (b) indicates the variation of the resistance of the conductive material.

As shown in FIG. 3, the resistance of the metal electrode increases with the temperature rises. On the other hand, the resistance of the conductive material decreases as the temperature rises. This shows that in the concentration detecting apparatus 2, the electrode resistance constituent Re, which is a resistance constituent attributed to the electrodes 8 or the like, increases as the temperature rises, and the fuel resistance constituent Rf attributed to the fuel mixture, which is a conductive material, decreases as the temperature rises.

As described above, the electrode resistance constituent Re and the fuel resistance constituent Rf vary with temperature in the opposite ways. To accurately detect the variation of the resistance attributed to the alcohol concentration of the fuel mixture, the variations of the resistance of the electrode resistance constituent Re and the fuel resistance constituent Rf with temperature that occur in the opposite ways have to be removed before the variation of the fuel resistance constituent Rf with alcohol concentration is measured.

The resistance value of the leads or the like forming the electrodes 8 or the detecting circuit of the concentration detecting apparatus 2 varies as the leads or the like deteriorate with time. In particular, the electrodes 8 are disposed in the fuel mixture and therefore can significantly deteriorate and significantly vary in resistance. Therefore, to accurately detect the variation of the resistance value with the alcohol concentration, it is also important to remove the variation of the electrode resistance constituent Re attributed to the deterioration of the electrodes 8.

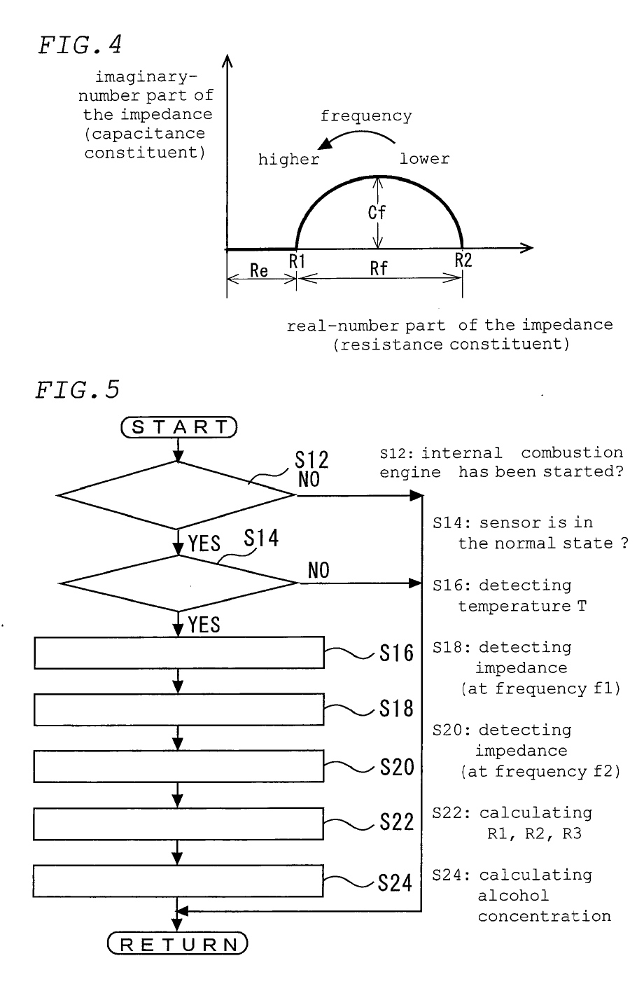

In view of the above description, according to the embodiment 1, an alternating-current voltage is applied to the circuit of the concentration detecting apparatus 2 so that the electrode resistance constituent Re and the fuel resistance constituent Rf can be separately detected as described below. FIG. 4 is a complex impedance plot showing a variation of the impedance of the concentration detecting apparatus 2 detected when an alternating-current voltage is applied to the detecting circuit of the concentration detecting apparatus 2 while sweeping (changing) the frequency of the alternating-current voltage. In FIG. 4, the horizontal axis indicates a real-number part (resistance constituent) of the impedance, and the vertical axis indicates an imaginary-number part (capacitance constituent).

As shown in FIG. 4, when an alternating-current voltage is applied to the circuit of the concentration detecting apparatus 2, the constituents attributed to the fuel classified above as the category (1) and the constituents attributed to the other factors (electrodes or the like) than the fuel classified above as the category (2) can be separately detected because of the difference in physical properties therebetween.

In FIG. 4, a resistance value R1 (first resistance constituent value) indicated by an intersection of the curve indicating the complex impedance and the x axis is the electrode resistance constituent Re. On the other hand, a resistance value R2 (second resistance constituent value) indicated by another intersection is a sum of the electrode resistance constituent Re and the fuel resistance constituent Rf. Therefore, if the resistance values R1 and R2 are detected, the fuel resistance constituent Rf can be determined according to Rf=R2−R1.

A first frequency f1 and a second frequency f2 corresponding to the resistance values R1 and R2 are fitted values that can be determined if the composition of the fuel mixture, the temperature range in which the fuel mixture is used or the like is identified to some extent. Therefore, in this embodiment 1, the first frequency f1 and the second frequency f2 are set by experiment or other means at appropriate values according to the composition or use environment of the fuel mixture and previously stored in the controller 12. In concentration detection, the first and second frequencies f1 and f2 previously stored are applied to detect the impedances, thereby detecting the resistance values R1 and R2.

In the embodiment 1, considering that the fuel mixture is an alcohol blended gasoline, for example, the first frequency f1 is set at a frequency of 10 [kHz] to 1 [MHz], and the second frequency f2 is set at a frequency of 100 [Hz] to 10 [kHz].

As can be seen from the above description, the fuel resistance constituent Rf determined from the resistance values R1 and R2 is considered as a resistance that includes no resistance attributed to the electrodes of the sensor and the like and is attributed only to the fuel. The fuel resistance constituent Rf has a correlation not only with the alcohol concentration but also with the temperature. Therefore, in this embodiment 1, the relations of the fuel resistance constituent Rf with the alcohol concentration and the temperature are previously found and stored in the controller 12 as a map. In concentration detection, the alcohol concentration is calculated based on the map using the fuel resistance constituent Rf and the temperature T of the fuel mixture determined from the output of the temperature sensor or the like as parameters.

FIG. 5 is a flowchart for illustrating a control routine performed by the controller in the embodiment 1 of the present invention. The routine shown in FIG. 5 is a routine that is repeatedly performed at regular intervals during operation of the internal combustion engine 4. According to the routine shown in FIG. 5, whether the internal combustion engine 4 has been started or not is first detected (S12). If the internal combustion engine 4 is out of service, detection of the fuel concentration is unnecessary, so that the routine ends.

However, if it is recognized that the internal combustion engine 4 has been started, it is then determined whether the concentration detecting apparatus 2 is in the normal state or not (S14). For example, if the concentration detecting apparatus 2 has not yet been warmed up to an operating temperature, it is not recognized that the concentration detecting apparatus 2 is in the normal state. If it is not recognized that the concentration detecting apparatus 2 is in the normal state, the routine ends.

However, if it is recognized in Step S14 that the concentration detecting apparatus 2 is in the normal state, the temperature T is then detected (S16). The temperature T is detected by the controller 12 in response to an output signal from a temperature sensor (not shown) disposed in the fuel path 6.

Then, an alternating-current voltage at the first frequency is applied to the circuit of the concentration detecting apparatus 2 to detect the impedance (S18). More specifically, the first frequency f1 previously stored in the controller 12 is read out, and the controller 12 outputs a predetermined control signal to the alternating-current power supply 10 to apply the alternating-current voltage at the first frequency f1 between the electrodes 8. Then, the resulting impedance is detected.

Then, an alternating-current voltage at the second frequency f2 is applied to the circuit of the concentration detecting apparatus 2 to detect the impedance (S20). More specifically, the second frequency f2 previously stored in the controller 12 is read out. Then, the controller 12 outputs a predetermined control signal to the alternating-current power supply 10 to apply the alternating-current voltage at the second frequency f2 between the electrodes 8, and the resulting impedance is detected.

Then, based on the impedances detected in Steps S18 and S20, the fuel resistance constituent Rf is determined (S22). The fuel resistance constituent Rf is the difference between the resistance value R1 determined from the impedance associated with the first frequency and the resistance value R2 determined from the resistance constituent associated with the second frequency and is determined according to the formula: the fuel resistance constituent Rf=resistance value R2−resistance value R1.

Then, based on the fuel resistance constituent Rf and the current temperature T, the alcohol concentration is calculated (S24). The alcohol concentration is determined according to the map that indicating the relationship among the temperature T, the fuel resistance constituent Rf and the alcohol concentration. The map is previously stored in the controller 12. Then, the routine ends.

As described above, according to the embodiment 1, the electrode resistance constituent Re attributed to the electrodes 8 and the like and the fuel resistance constituent Rf attributed to the fuel can be separately detected. The alcohol concentration of the fuel mixture can be detected relying only on the variation of the fuel resistance constituent Rf attributed to the fuel by removing the influence of the variation of the resistance value due to deterioration or temperature variation of the electrodes 8 or the like. Therefore, the alcohol concentration can be more accurately detected.

In the embodiment 1, a case has been described where the resistance values R1 and R2 are determined from the impedances in the cases where the alternating-current voltages at the first and second frequencies f1 and f2 are applied. However, the present invention is not limited to this implementation. For example, the resistance values R1 and R2 may be determined according to an alternating-current impedance method by performing a plurality of concentration detections by sweeping the frequency from a lower frequency to a higher frequency in each concentration detection.

Besides, in the case described above, the temperature of the fuel mixture is detected, and the fuel concentration is determined from the temperature and the value of the fuel resistance constituent Rf. However, the present invention is not limited to this implementation. If the variation of the value of the fuel resistance constituent Rf with the temperature is negligible, the fuel concentration can be determined from only the value of the fuel resistance constituent Rf.

In the embodiment 1, to perform Step S16 implements “temperature detecting means” according to the present invention, to perform Steps S18, S20 and S22 implements “resistance constituent detecting means”, and to perform Step S24 implements “concentration estimating means”.

### Embodiment 2

A concentration detecting apparatus according to an embodiment 2 has the same configuration as the apparatus shown in FIG. 1. The concentration detecting apparatus according to the embodiment 2 differs from the apparatus according to the embodiment 1 only in that the temperature of the fuel mixture as well as the alcohol concentration is detected.

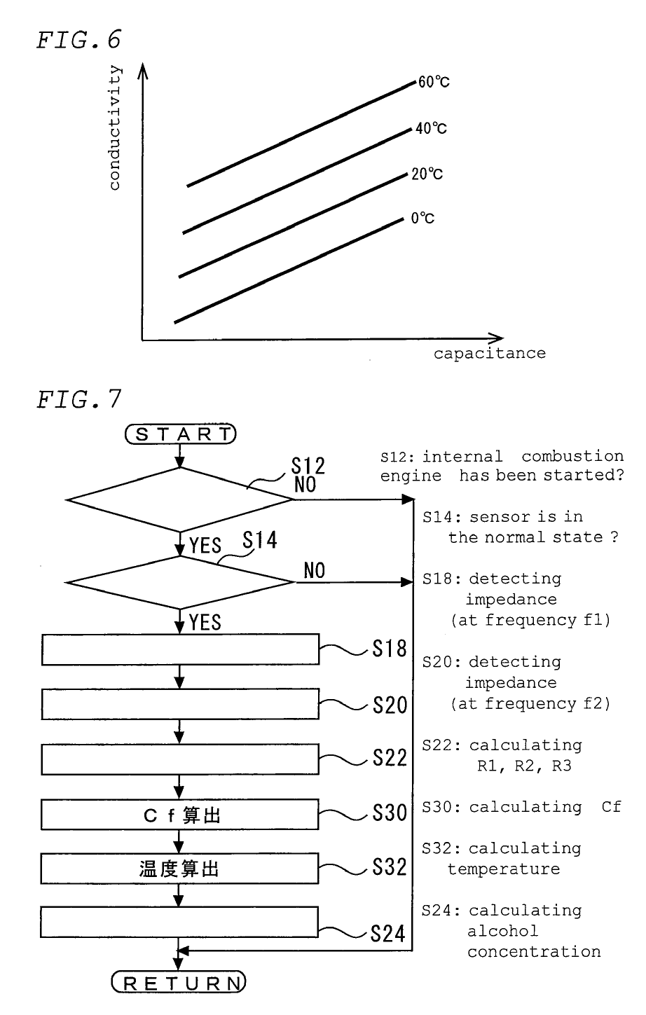

FIG. 6 is a graph for illustrating a relationship between the conductivity (the inverse of the resistance value) and the capacitance of the fuel. As described above, the fuel resistance constituent has a correlation with the temperature. As shown in FIG. 6, the capacitance of the fuel also has a correlation with the temperature and varies with the temperature. More specifically, the conductivity increases as the temperature rises, whereas the capacitance decreases as the temperature rises. In addition, the conductivity has a correlation with the alcohol concentration as described above. Therefore, the alcohol concentration and the temperature can be detected at the same time by using the conductivity and the capacitance as parameters.

The controller 12 stores the relationship among the conductivity, the capacitance and the temperature shown in FIG. 6 in the form of a map. The fuel concentration and the temperature can be detected at the same time by detecting the conductivity (resistance value) and the capacitance.

The value of the capacitance of the fuel mixture is taken when the fuel-derived capacitance constituent Cf is at the maximum in FIG. 4 described earlier. The frequency and the value of the resistance constituent at the time when the fuel-derived capacitance constituent Cf is at the maximum are referred to as a third frequency f3 and a resistance value R3, respectively. Then, the relationship expressed by the following formula (1) holds.

R3Cf=1/(2πf3) (1)

The resistance value R3 can be approximately considered to be an intermediate value between the resistance value R1 and the resistance value R2 in FIG. 4 and is assumed in this example to satisfy the relation: R3=R1+R2/2. The third frequency f3 at the time when the resistance value is the resistance value R3 is previously identified. As with the first and second frequencies f1 and f2, the third frequency f3 is a fitted value that can be determined if the composition of the fuel mixture, the temperature range in which the fuel mixture is used or the like is identified to some extent. Therefore, in this embodiment 2, the third frequency f3 as well as the first frequency f1 and the second frequency f2 is determined by experiment or other means according to the composition or use environment of the fuel mixture and previously stored in the controller 12. The fuel-derived capacitance constituent Cf can be calculated by substituting the third frequency f3 and the resistance value R3 into the formula (1) described above.

FIG. 7 is a flowchart for illustrating a control routine according to the embodiment 2 of the present invention. The routine shown in FIG. 7 differs from the routine shown in FIG. 5 only in that the processing of Step S16 in FIG. 5 is omitted, and processings of Steps S30 and S32 follow the processing of Step S22.

Specifically, according to the routine shown in FIG. 7, after the processing of Step S22, the fuel-derived capacitance constituent Cf is calculated (S30). More specifically, the fuel-derived capacitance constituent is calculated by substituting the resistance values R1 and R2 calculated in Step S22 and the third frequency f3 previously stored in the controller 12 into the formula (1) described above.

Then, the temperature of the fuel mixture is calculated (S32). The temperature is calculated based on the map previously stored in the controller 12 according to the inverse of the fuel resistance constituent Rf calculated in Step S22 (that is, the conductivity) and the value of the fuel-derived capacitance constituent Cf.

Then, the alcohol concentration is determined (S24). In this example, the alcohol concentration is determined from the temperature calculated in Step S32 and the fuel resistance constituent Rf.

As described above, according to the embodiment 2, not only the alcohol concentration but also the temperature of the fuel mixture can be detected by one and the same apparatus. Therefore, there is no need for installing a temperature sensor or the like, so that the cost and size of the system can be reduced.

In the embodiment 2, a case has been described where the fuel-derived capacitance constituent Cf is determined from the third frequency f3 determined previously and the resistance value R3 determined approximately from the resistance values R1 and R2. However, the present invention is not limited to this implementation. For example, the fuel-derived capacitance constituent Cf may be determined from a complex impedance curve such as shown in FIG. 4 by changing the frequency a plurality of number of times.

In the embodiment 2, to perform Step S30 implements “capacitance constituent calculating means” according to the present invention, and to perform Step S32 implements “temperature estimating means” according to the present invention.

### Embodiment 3

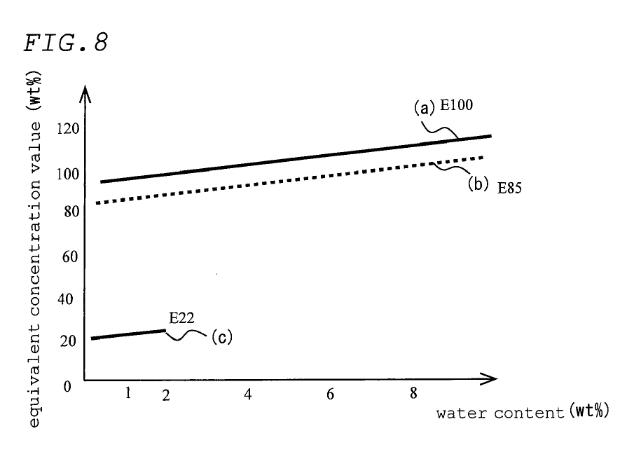

FIG. 8 is a graph for illustrating a variation of an equivalent concentration value calculated by a concentration detecting apparatus with respect to a variation of the water content of a fuel mixture according to an embodiment 3 of the present invention. In this drawing, the horizontal axis indicates the water content [wt %], and the vertical axis indicates the equivalent concentration value [wt %]. The lines (a), (b) and (c) represent cases where the initial concentration of ethanol in the fuel mixture is 100%, 85% and 22%, respectively.

The dielectric constant of water is approximately 3.3 times higher than that of ethanol. Therefore, when the fuel mixture containing gasoline and ethanol is used, if the water content of the ethanol increases by 1%, the capacitance increases by 1.5%. Therefore, in the case shown by the line (b) where the concentration of the ethanol blended with the gasoline in the fuel is 85%, for example, when the water content increases by 1%, the detection value shows that the ethanol concentration has increased by 1.5%.

In this way, there is a correlation between the water content of the fuel mixture and the variation of the capacitance. In addition, since the alcohol concentration of the fuel mixture varies, the conductivity also varies accordingly. Therefore, there is a particular correlation between the fuel resistance constituent Rf and the water content.

Therefore, if the constituents of the fuel mixture are identified, the alcohol concentration of the fuel mixture can be determined and the water concentration of the fuel mixture can be determined by using the fuel-derived capacitance constituent Cf, the fuel resistance constituent Rf and the temperature detected by the temperature sensor as parameters. In the embodiment 3, the relationships between the fuel-derived capacitance constituent Cf, the fuel resistance constituent Rf and the temperature T and the alcohol concentration and the water concentration are previously determined by experiment or other means and stored in the controller 12 in the form of a map. In actual concentration detection, the fuel-derived capacitance constituent Cf, the fuel resistance constituent Rf and the temperature T are determined according to the method described in the embodiment 1 or 2, and the alcohol concentration and the water concentration are determined based on the map.

As described above, in the embodiment 3, the water concentration of the fuel mixture can be detected by detecting the fuel-derived capacitance constituent Cf and the fuel resistance constituent Rf. Therefore, both the alcohol concentration and the water concentration can be detected by one and the same apparatus, and the properties of the fuel can be more accurately grasped without increasing the size of the apparatus.

### DESCRIPTION OF NOTATIONS

2 concentration detecting apparatus
4 internal combustion engine
6 fuel path
8 electrodes
10 alternating-current power supply
12 control apparatus

1. A concentration detecting apparatus that detects an alcohol concentration of an alcohol blended fuel, comprising:
a frequency controlling device that controls a frequency of an alternating-current voltage applied between a pair of electrodes spaced apart from each other;
a resistance constituent value detecting device that detects a first resistance constituent value between the electrodes in a case where an alternating-current voltage is applied at a first frequency at which a capacitance constituent value of an impedance is zero and detects a second resistance constituent value between the electrodes in a case where an alternating-current voltage is applied at a second frequency different from the first frequency at which the capacitance constituent value of the impedance is zero; and
a concentration estimating device that estimates the alcohol concentration based on the difference between the first resistance constituent value and the second resistance constituent value.

2. The concentration detecting apparatus according to claim 1, further comprising:
a temperature detecting device that detects a temperature of the alcohol blended fuel,
wherein the concentration estimating device estimates the alcohol concentration based on the difference between the first resistance constituent value and the second resistance constituent value and the temperature detected by the temperature detecting device.

3. The concentration detecting apparatus according to claim 1, further comprising:
a capacitance constituent value calculating device that calculates the capacitance constituent value between the electrodes in a case where an alternating-current voltage is applied at a predetermined third frequency between the first frequency and the second frequency; and
a temperature estimating device that determines a temperature of the alcohol blended fuel based on the difference between the first resistance constituent value and the second resistance constituent value and the capacitance constituent value.

4. The concentration detecting apparatus according to claim 1, further comprising:
a temperature detecting device that detects the temperature of the alcohol blended fuel;
a capacitance constituent value calculating device that calculates the capacitance constituent value between the electrodes in a case where an alternating-current voltage is applied at a predetermined third frequency between the first frequency and the second frequency; and
a water concentration calculating device that calculates a water concentration of the alcohol blended fuel based on the difference between the first resistance constituent value and the second resistance constituent value, the capacitance constituent value and the temperature detected by the temperature detecting device.

5. The concentration detecting apparatus according to claim 2, further comprising:
a temperature detecting device that detects the temperature of the alcohol blended fuel;
a capacitance constituent value calculating device that calculates the capacitance constituent value between the electrodes in a case where an alternating-current voltage is applied at a predetermine third frequency between the first frequency and the second frequency; and
a water concentration calculating device that calculates a water concentration of the alcohol blended fuel based on the difference between the first resistance constituent value and the second resistance constituent value, the capacitance constituent value and the temperature detected by the temperature detecting device.

6. A concentration detecting apparatus that detects an alcohol concentration of an alcohol blended fuel by:
controlling a frequency of an alternating-current voltage applied between a pair of electrodes spaced apart from each other;
detecting a first resistance constituent value between the electrodes in a case where an alternating-current voltage is applied at a first frequency at which a capacitance constituent value of an impedance is zero;
detecting a second resistance constituent value between the electrodes in a case where an alternating-current voltage is applied at a second frequency different from the first frequency at which the capacitance constituent value of the impedance is zero; and
estimating the alcohol concentration based on the difference between the first resistance constituent value and the second resistance constituent value.
